(19) United States
(12) Patent Application Publication
(10) Pub. No.: US 2006/0042331 A1
(43) Pub. Date: Mar. 2, 2006

(54) Lockbox

(76) Inventor: Steven J. Benda, Cokato, MN (US)

Correspondence Address: QUARLES & BRADY LLP, 411 E. WISCONSIN AVENUE, SUITE 2040, MILWAUKEE, WI, 53202-4497, US

(21) Appl. No.: 10/927,758

(22) Filed: Aug. 27, 2004

(51) Int. Cl. E05B 65/52

(52) U.S. Cl. 70/63; 70/159

(57) ABSTRACT

A lockbox including an enclosure defining an opening. A lid is fixed relative to the enclosure for movement between an open position and a closed position. In the closed position, the lid covers the enclosure opening to discourage access to contents of the enclosure by an unauthorized user. A lock rail is slidably fixed to one of the lid and the enclosure for slidable movement between a lock position and an unlock position. In the lock position, the lock rail engages the other of the lid and the enclosure to prevent moving the lid from the closed position to the open position.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The field of invention is lockboxes, and in particular lockboxes for use in lockout/tag out (LOTO) procedures for securing equipment being serviced or maintained.

LOTO procedures require the installation of locks and tags on energy isolation devices, such as circuit breakers, lock switches, and the like, to cut off power to equipment being serviced or maintained. The locks, tags, and keys for the locks are often stored in lockboxes that can themselves be locked to prevent an unauthorized user from obtaining the keys, locks, and tags.

Lockboxes known in the art are typically metal boxes having a conventional clasp that can be locked by a single padlock. Unfortunately, because the prior art lockboxes can be locked by only a single padlock, unlocking the single padlock provides access to all of the contents of the lockbox. This is a problem when more than one user is independently concerned about access to the contents by an unauthorized user. Accordingly, a need exists for a lockbox that can be locked by more than one user.

It is also advantageous to provide a window in the lockboxes in order to allow individuals to view the contents in the lockbox before attempting to gain access to the contents. Providing a window in the prior art lockboxes significantly increases the cost of the lockbox. Accordingly, a need exists for an inexpensive lockbox that allows a user to view the contents of the lockbox without first opening the lockbox.

### BRIEF SUMMARY OF THE INVENTION

The present invention provides a lockbox including an enclosure defining an opening. A lid is fixed relative to the enclosure for movement between an open position and a closed position. In the closed position, the lid covers the opening to discourage access to contents of the enclosure by an unauthorized user. A lock rail is slidably fixed to one of the lid and the enclosure for slidable movement between a lock position and an unlock position. In the lock position, the lock rail engages the other of the lid and the enclosure to prevent moving the lid from the closed position to the open position. In one embodiment, the lock rail includes a plurality of openings for receiving a hasp of a locking mechanism. In another embodiment, at least one of the lid and an enclosure wall is formed from a clear plastic.

A general objective of the present invention is to provide a lockbox than can be locked by more than one user. This objective is accomplished by providing a lockbox having a lid locked by a slidable lock rail. The lock rail includes a plurality of openings. At least some of the lock rail openings are capable of receiving a hasp of a locking mechanism for locking the lid in the closed position to allow more than one user to lock the lockbox.

Another objective of the present invention is to provide an inexpensive lockbox that allows a user to view the contents of the lockbox. This objective is accomplished by providing a lockbox having at least one of a portion of the enclosure and the lid formed from a clear plastic.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a front, bottom perspective view of a lockbox incorporating the present invention;

FIG. 2 is a front perspective view of the enclosure of FIG. 1;

FIG. 3 is a cross sectional view along line 3-3 of FIG. 2;

FIG. 4 is a rear, top perspective view of the lockbox of FIG. 1;

FIG. 5 is a bottom view of the lockbox of FIG. 1;

FIG. 6 is a top perspective view of the lid of FIG. 1;

FIG. 7 is a detailed perspective view of the enclosure and lid hinge members of FIG. 1;

FIG. 8 is a front perspective view of the lock rail of FIG. 1;

FIG. 9 is a rear perspective view of the lock rail of FIG. 8;

FIG. 10 is a cross sectional view along line 10-10 of FIG. 1;

FIG. 11 is a perspective view of the key hook of FIG. 2;

FIG. 12 is a perspective view of the hinge pin of FIG. 1;

FIG. 13 is a front, bottom perspective view of an alternative lockbox incorporating the present invention;

FIG. 14 is a rear, top perspective view of the lockbox of FIG. 13;

FIG. 15 is a front perspective view of the enclosure of FIG. 13; and

FIG. 16 is a front perspective view of the lid of FIG. 13.

### DETAILED DESCRIPTION OF THE PREFERRED EMBODIMENTS

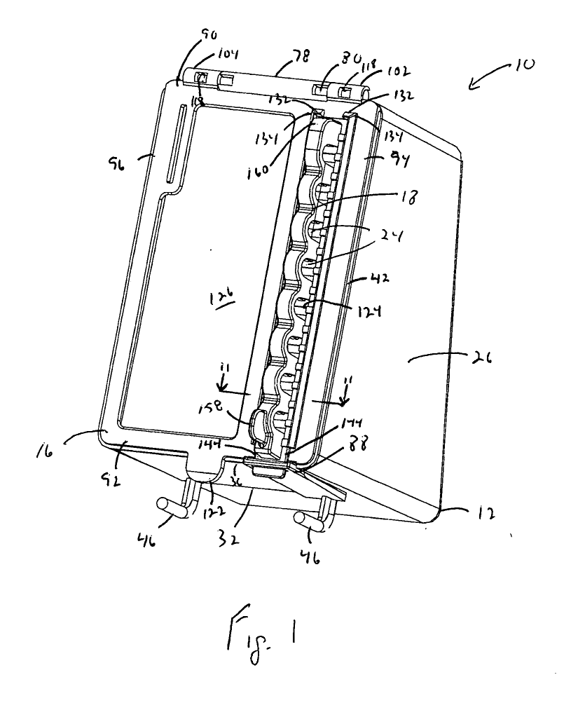

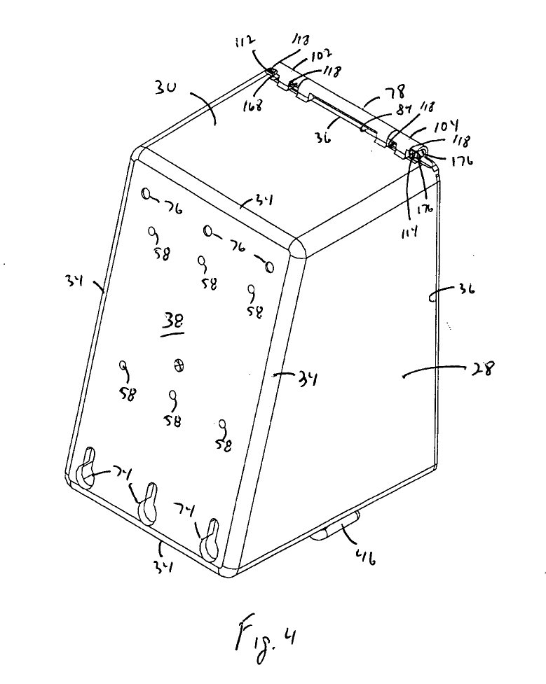

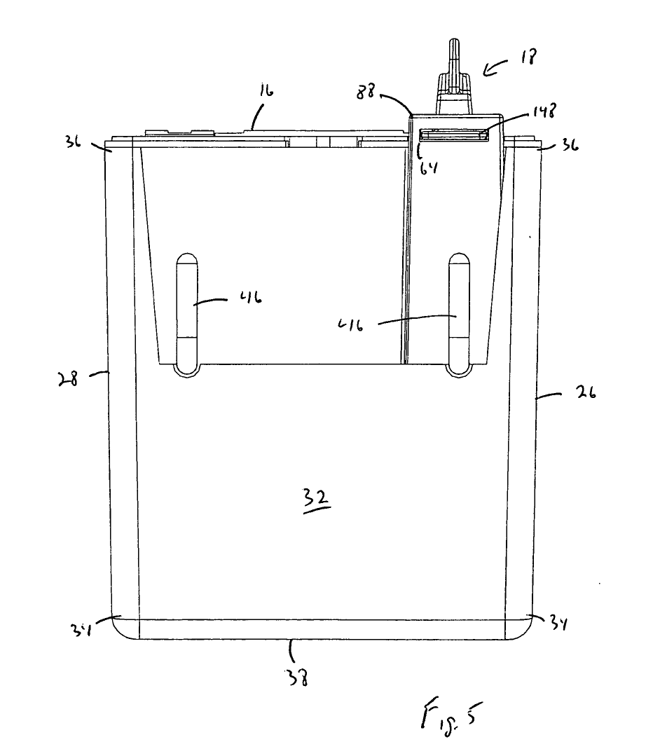

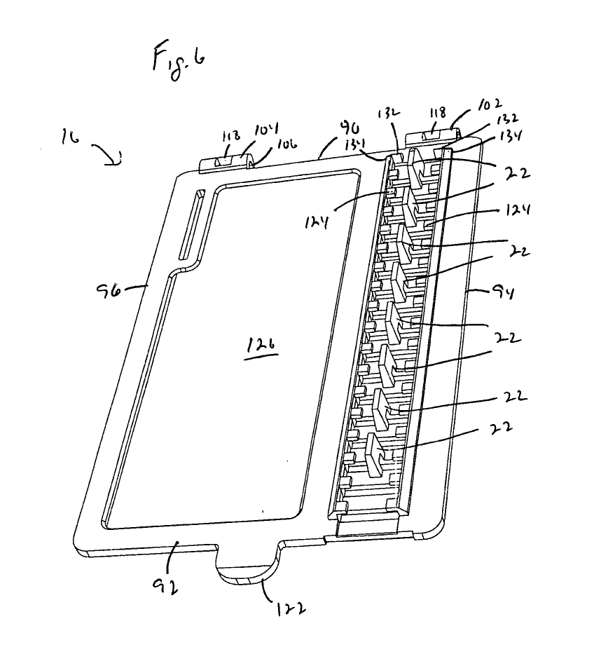

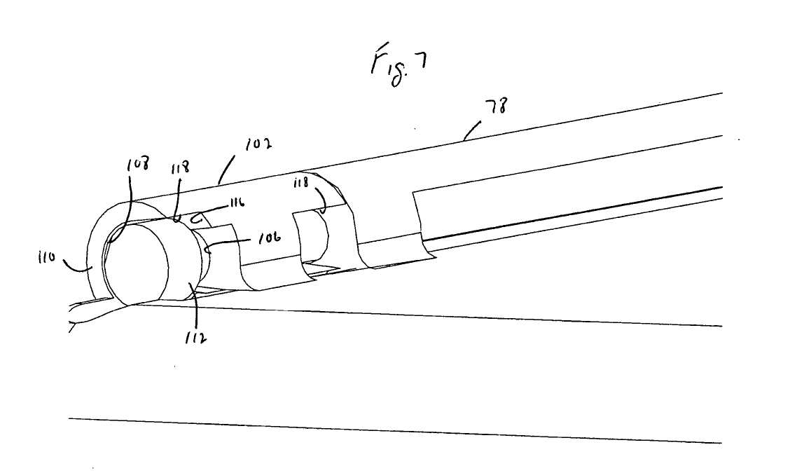

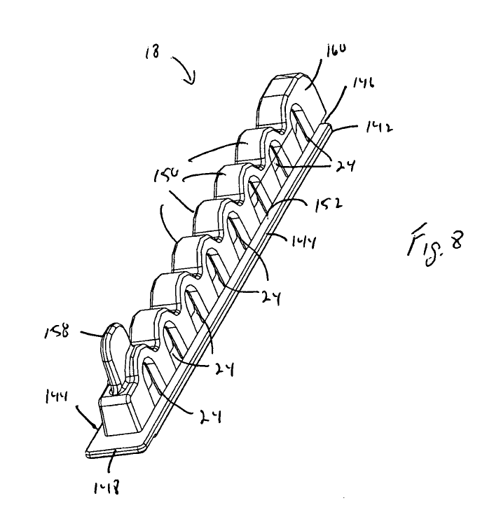

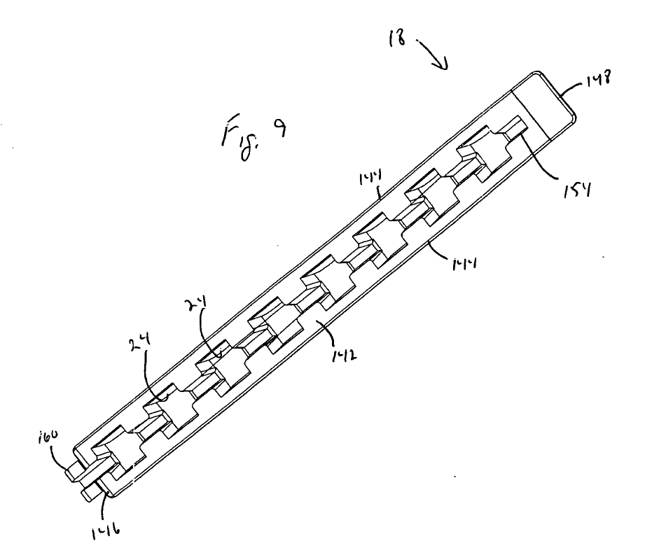

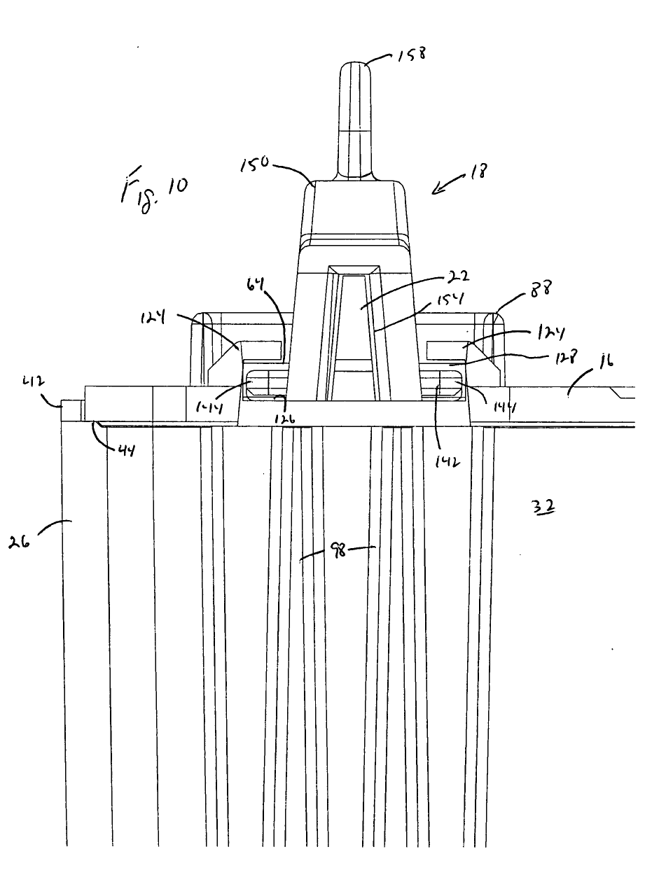

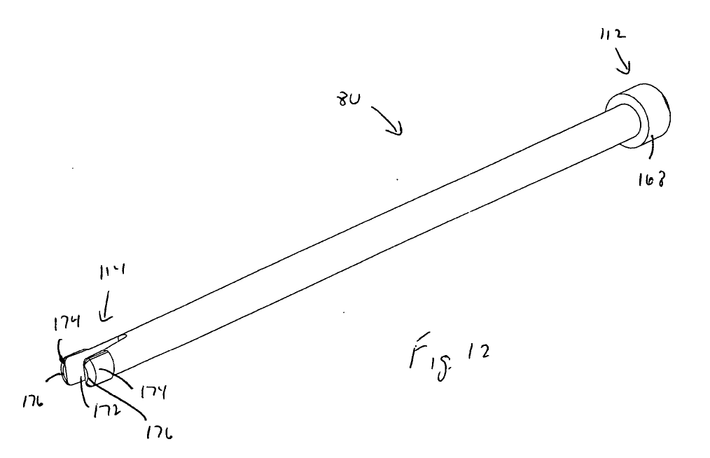

Referring to FIGS. 1-12, a lockbox 10 incorporating the present invention includes an enclosure 12 for receiving objects, such as keys, locks, and the like. The enclosure 12 defines an enclosure opening 14 that is closed by a lid 16 that is lockable to prevent an unauthorized user from obtaining the objects in the enclosure 12. The lid 16 is locked by a lock rail 18 slidably fixed to the lid 16. The lock rail 18 selectively engages the enclosure 12 to lock the lid 16 over the enclosure opening 14. Lock cleats 22 extending outwardly from the lid 16 cooperate with lock rail openings 24 formed through the lock rail 18, such that a hasp (not shown) of a locking mechanism inserted through one of the lock rail openings 24 locks the lid 16 over the enclosure opening 14. The hasp received through the lock rail opening 24 is engagable with one of the lock cleats 22 to prevent slidable movement of the lock rail 18 to unlock the lid 16.

Referring to FIGS. 1-5, the rectangular enclosure 12 includes opposing side walls 26, 28 joined by top and bottom end walls 30, 32. The sidewalls 26, 28 and end walls 30, 32 have inner and outer edges 34, 36. The inner edges 34 of both the side walls 26, 28 and end walls 30, 32 are joined by a back wall 38. The outer edges 36 of both the side walls 26, 28 and end walls 30, 32 define the enclosure opening 14 into the enclosure 12. Preferably, the walls 26, 28, 30, 32 are formed from a high strength molded plastic, such GF Nylon, GF Isoplast, and the like. However, the enclosure can be formed from any suitable material, such as metal, plastic, and the like, without departing from the scope of the invention. Moreover, although a rectangular enclosure 12 is disclosed, the enclosure 12 can have any number of side and/or end walls 26, 28, 30, 32 which define the enclosure opening 14.

The bottom end wall 32 extends further from the back wall 38 than the top end wall 30 to slope the outer edges 36 of the side walls 26, 28 from the top end wall 30 outwardly to the bottom end wall 32. Advantageously, when the lockbox 10 is mounted to a vertical surface, the sloped outer edges 36 of the side walls 26, 28 provide an angled support for the lid 16, as well as, a larger bottom end wall 32 for supporting objects inside the enclosure 12. Although sloping the outer edges 36 of the side walls 26, 28 is preferred, the outer edges 36 of the side walls 26, 28 can be vertical without departing from the scope of the claims.

An enclosure opening lip 42 formed on the outer edges 36 of the side walls 26, 28 and bottom end wall 32 defines a ledge 44 for supporting the lid 16 thereon. The enclosure opening lip 42 abuts the adjacent lid edges 92, 94, 96 to prevent tampering. Although forming an enclosure opening lip 42 on the outer edges 36 of the side walls 26, 28 and bottom end wall 32 of the enclosure 12 is preferred, the enclosure opening lip 42 can be eliminated without departing from the scope of the claims.

A pair of hooks 46 extending downwardly from the bottom end wall 32 of the enclosure 12 can be provided for hanging objects, such as clipboards, safety glasses, and the like. Preferably, the hooks 46 are formed as an integral part of the enclosure 12. However, the hooks 46 can be attached to the end walls 30, 32 and side walls 26, 28 using any methods known in the art, such as bonding, mechanical fasteners, and the like, without departing from the scope of the invention.

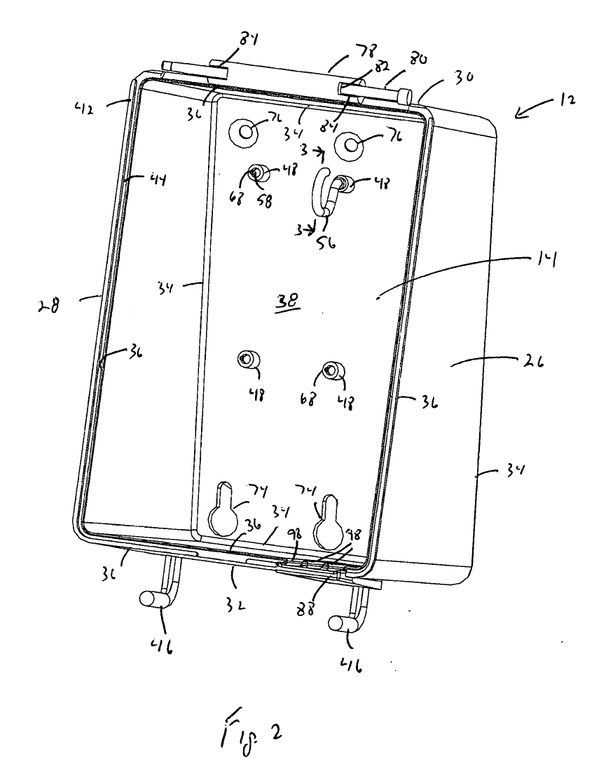

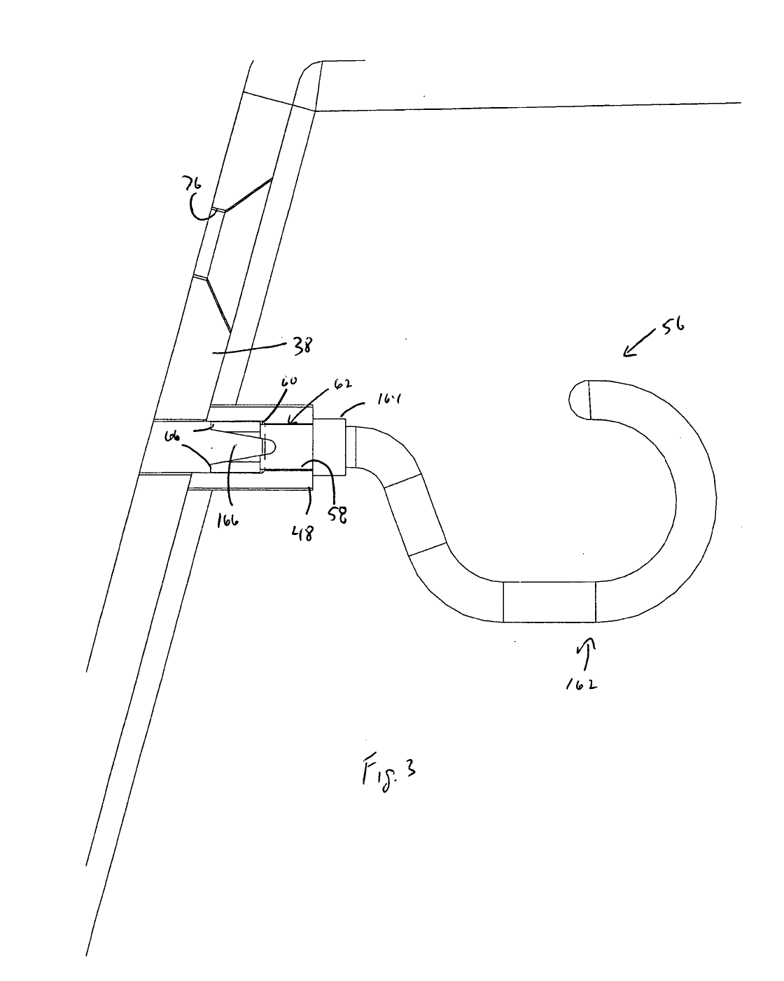

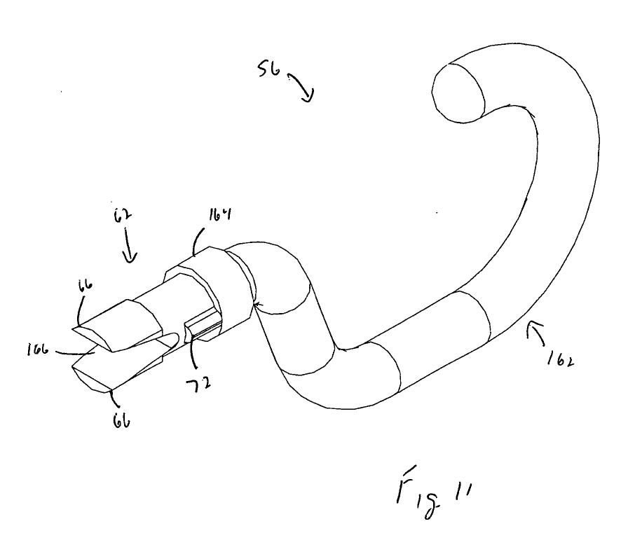

As best shown in FIGS. 2 and 3, the back wall 38 includes a plurality of key hook bosses 48 extending inwardly into the enclosure 12 for supporting key hooks 56. Preferably, the key hook bosses 48 are arranged in a grid pattern on the back wall 38, such that a user can install the key hooks 56 in any pattern or location allowed by the key hook bosses 48. Each of the key hook bosses 48 includes an opening 58 or throughhole for receiving an insertion end 62 of one of the key hooks 56. A step 60 formed in the opening 58 engages resilient barbs 66 extending from the key hook 56 to fix the key hook 56 in the key hook bosses 48. Preferably, each opening 58 of the key hook bosses 48 includes an axially extending slot 68 for receiving a rib 72 (shown in FIG. 11) extending from the insertion end 62 of the key hook 56. The rib 72 is received in the slot 68 to ensure the key hook 56 is properly oriented in the key hook boss 48.

Referring back to FIGS. 1-5, mounting holes 74, 76 formed through the back wall 38 receives mechanical fasteners, such as screws, bolts, nails, and the like, therethrough for mounting the enclosure 12 to a wall, or other support structure. The upper mounting holes 76 are countersunk, such that the head of a mounting screw is flush with the back wall 38. The lower mounting holes 74 are slotted for slipping a head of a mounting screw therethrough to simplify mounting the enclosure 12. Of course, mounting holes 74, 76 are not required, and enclosure can be free standing or secured to a wall, table, or other structure, without the use of preformed mounting holes without departing from the scope of the invention.

An enclosure hinge member 78 formed on the outer edge 36 of the top end wall 30 receives a hinge pin 80 to hingedly fix the lid 16 to the enclosure 12. The elongated barrel-shaped enclosure hinge member 78 includes a throughhole 82 extending parallel to the outer edge 36 of the top end wall 30 for receiving the hinge pin 80 therethrough. Of course, one or more enclosure hinge members 78 can be provided, and the enclosure hinge members 78 can be formed on an outer edge 36 of any of the enclosure walls 26, 28, 30, 32 without departing from the scope of the invention. Moreover, hingedly fixing the lid 16 to the enclosure 12 is not required, and the lid 16 can be placed over the enclosure opening 14 without departing from the scope of the invention. Advantageously, axially extending slots 84 formed in the enclosure hinge member 78 simplify molding the enclosure hinge member 78 by eliminating the need for cams or slides in the mold.

A body cleat 88 extending outwardly from the outer edge 36 of the enclosure bottom end wall 32 engages the lock rail 18 to lock the lid 16 over the enclosure opening 14. The body cleat 88 includes an aperture 64 for receiving the lock rail 18 therethrough to engage the lock rail 18 with the body cleat 88. Body cleat ribs 98 formed in the enclosure bottom end wall 32 strengthen the body cleat 88 to prevent an unauthorized user from deforming the body cleat 88 to gain access to the inside of the enclosure 12.

Preferably, the body cleat 88 is formed as an integral part of the enclosure 12. However, the body cleat 88 can be formed separately from the enclosure 12, and fixed thereto using methods known in the art, such as bonding, mechanical fasteners, and the like, without departing from the scope of the invention. Moreover, the body cleat 88 can be an aperture formed through a wall 26, 28, 30, 32 of the enclosure 12. The body cleat 88 described herein is considered part of the enclosure 12 whether the body cleat 88 is formed as a separate piece from the enclosure 12, an integral part of the enclosure 12, or an aperture formed through one of the enclosure walls 26, 28, 30, 32.

Referring to FIGS. 1-10, the generally flat lid 16 is hingedly fixed to the enclosure 12 by the hinge pin 80 for pivotal movement between an open position and a closed position, and includes a top edge 90 and bottom edge 92 joined by side edges 94, 96. In the open position, the lid 16 is clear of the enclosure opening 14 for depositing or retrieving objects from within the enclosure 12. In the closed position, the lid 16 covers the enclosure opening 14. Advantageously, in the closed position, the lid edges 92, 94, 96 are covered by the enclosure opening lip 42 to prevent an unauthorized user from prying the lid 16 off of the enclosure 12. Preferably, the lid 16 is formed from a clear plastic, such as clear moldable nylon, polystyrene, polycarbonate, and the like, for clear viewing of the enclosure contents. Although a clear lid is preferred, the lid 16 can be formed from any suitable material, such as any plastic, metal, and the like, without departing from the scope of the invention.

A pair of lid hinge members 102, 104 formed in the top edge 90 of the lid 16 receives the hinge pin 80 to hingedly fix the lid 16 to the enclosure 12. The barrel-shaped lid hinge members 102, 104 are spaced apart to receive the enclosure hinge member 78 therebetween, and include openings 106 coaxial with the throughhole 82 formed through the enclosure hinge member 78. Receptacles 108 formed in outwardly facing ends 110 of each lid hinge member 102, 104 receive one of a head end 112 and tail end 114 of the hinge pin 80. Advantageously, each receptacle 108 covers the head end 112 and tail end 114 to discourage tampering, and includes an engagement wall 116 that engages the head end 112 or tail end 114, respectively, to prevent further axial movement of the hinge pin 80 through the hinge members 78, 102, 104. Axially extending notches 118 formed in each lid hinge member 102, 104 simplify molding the lid hinge members 102, 104 by eliminating the need for cams or slides in the mold.

A lift tab 122 extending from the bottom edge 92 of the lid 16 extends downwardly past the bottom end wall 32 of the enclosure 12. The lift tab 122 provides a handle for the user pivoting the lid 16 from a closed position over the enclosure opening 14 to an open position which provides access to the user for transferring objects into and out of the enclosure 12 through the enclosure opening 14. Although the lift tab 122 is preferred, it is not required to practice the invention.

A pair of spaced notched hook-shaped lips 124 formed in an outer surface 126 of the lid 16 opens toward each other substantially parallel to the lid outer surface 126 to form a gap 128 between the outer surface 126 and the lips 124. The longitudinally extending lips 124 are parallel to the side walls 26, 28 of the enclosure 12, and slidably fix the lock rail 18 to the lid 16. Preferably the lips 124 are proximal one of the side walls 28 to provide a clear view of the contents of the enclosure 12 through the lid 16. A stop 132 formed at an upper end 134 of each lip 124 prevents the lock rail 18 from sliding past the upper end 134 of the lips 124. Although notches formed in the lips 124 are shown and described to minimize the material required to form the lips 124, the lips can be unnotched without departing from the scope of the invention.

The lock cleats 22 extending upwardly from the lid outer surface 126 are spaced apart and centrally aligned between the lips 124. The lock cleats 22 cooperate with the lock rail openings 24 formed through the lock rail 18, such that a hasp of a locking mechanism inserted through one of the lock rail openings 24 engages one of the lock cleats 22 to prevent slidable movement of the lock rail 18 to open the lid 16. Preferably, the lock cleats 22 are formed as an integral part of the lid 16. However, the lock cleats 22 can be formed independent of the lid 16 and fixed thereto, such as by bonding, mechanical fasteners, and the like, without departing from the scope of the invention.

Referring to FIGS. 1, 2, and 8-10, the lock rail 18 is slidably mounted over the lock cleats 22 for slidable movement between a lock position and an unlock position, and includes a rectangular lock rail base 142 having longitudinal edges 144 joined by upper and lower ends 146, 148. A plurality of arches 150 extend from the lock rail base top 152 between the upper end 146 and a lower end 148, and define a plurality of the transverse lock rail openings 24 above the lock rail base 142. A longitudinal slot 154 formed through the lock rail base 142 and in the arches 150 slidably receives the lock cleats 22 to slidably mount the lock rail 18 over the lock cleats 22. Advantageously, by providing a lock rail 18 having a plurality of lock rail openings 24, multiple users can individually lock the lockbox 10 independent of each other to ensure the objects in the lockbox 10 are not accessed until all of the users unlock the lockbox 10.

Preferably, the arches 150 are formed as an integral part of the lock rail base 142, and include a tab 158 extending outwardly proximal the lower end 148 of the lock rail base 142 for grasping by the user to move the lock rail 18 between the lock position and the unlock position. An extension 160 extending upwardly from the uppermost arch 150 proximal the top edge 90 of the lid 16 minimizes discomfort to the user if the user urges the lock rail 18 to the lock position by pushing on the extension 160. Although arches 150 are described herein, other structures can be provided to form lock rail openings 24 above or in the lock rail base 142 for receiving the hasp therethrough, such as open ended boxes, through bores formed in the lock rail base 142, and the like, without departing from the scope of the present invention.

The hook-shaped lid lips 124 wrap over the longitudinal edges 144 of the lock rail base 142, such that the longitudinal edges are received in the gaps 128 between the lid lips 124 and lid outer surfaces 126, to slidably fix the lock rail 18 to the lid 16 for slidable movement between the lock and unlock positions. In the lock position, the transverse lock rail openings 24 formed in the lock rail 18 are disposed between adjacent lock cleats 22 to allow the hasp of the locking mechanism through the lock rail openings 24, and the lower end of the lock rail base 142 engages the body cleat 88 by extending through the body cleat aperture 64 to lock the lid 16 over the enclosure opening 14. In the unlock position, the lower end 148 of the lock rail base 142 is disengaged from the body cleat 88 and each transverse lock rail opening 24 is preferably aligned with one of the lock cleats 22 to prevent a user from inserting a hasp through the lock rail opening 24 and inadvertently lock the lock rail 18 in the unlock position.

As shown in FIGS. 2, 3, and 11, each key hook 56 inserted into one of the key hook bosses 48 includes a hook end 162 and the insertion end 62. A stop collar 164 encircling the key hook 56 separates the hook end 162 from the insertion end 62. The hook end 162 extends forwardly from the stop collar 164, and is hook shaped for hanging an object, such as a lock or key therefrom. The insertion end 62 extends rearwardly from the stop collar 164 into the key hook boss opening 58, and includes a diametrically and axially extending slot 166 defining the opposed resilient barbs 66 that engage the step 60 formed in the key hook boss opening 58 to fix the key hook insertion end 62 in the key hook bosses 48. Preferably, the rib 72 extending from the stop collar 164 toward the resilient barbs 66 is received in the slot 68 formed in the key hook boss opening 58 of the key hook boss 48 to orient the key hook 56, such that the key hook 56 opens upwardly for hanging the object thereon.

Referring to FIGS. 1, 2, 4, 7, and 12, the hinge pin 80 is received through the throughhole 82 formed in the enclosure hinge member 78 and the openings 106 formed in the lid hinge members 102, 104 to pivotally fix the lid 16 relative to the enclosure 12. The hinge pin 80 is preferably formed from a plastic material, and includes the head end 112 and a tail end 114.

The head end 112 of the hinge pin 80 includes a head 168 having a diameter larger than the diameter of the opening 106 formed in each of the lid hinge members 102, 104, and is received in one of the receptacles 108 formed in one of the lid hinge members 102, 104. The head 168 engages the engagement wall 116 formed at the junction of the receptacle 108 and opening 106 of one lid hinge member 104 to prevent further axial movement of the hinge pin 80 through the hinge members 78, 102, 104.

The tail end 114 of the hinge pin 80 includes a diametrically and axially extending slot 172 defining opposed barbs 174 having outer ends 176 received in the receptacle 108 of the other lid hinge member 102. The barbs 174 have a dimension greater than the dimension of the opening 106 in the lid hinge member 102 so as to normally be impassable through the opening 106 in the lid hinge member 102. Advantageously, the barbs 174 normally prevent axially outward passage of the hinge pin 80 through the lid hinge members 102, 104 and only permit passage of the hinge pin 80 through the opening 106 in the lid hinge members 102, 104 when the barbs 174 are displaced toward each other.

Referring now to FIGS. 1-12, in use, the lockbox 10 is mounted on a support structure, such as a wall, by moving the lid 16 to the open position and inserting mechanical fasteners, such as screws, through the mounting holes in the enclosure back wall 38. The mechanical fasteners are then secured to the supporting structure using methods known in the art, such as a power drill. The insertion end 62 of each key hook 56 is then inserted into one of the desired key hook boss openings 58 to mount each key hook 56 in the lockbox enclosure 12 to provide support locations for objects stored in the lockbox enclosure 12. Of course, the key hooks 56 can be inserted into the key hook boss openings 58 prior to mounting the lockbox 10 on the support structure without departing from the scope of the invention.

Once the desired objects are placed in the lockbox enclosure 12, the lid 16 is pivoted to the closed position, and the lock rail 18 is slid from the unlock position to the lock position. In the lock position, the lock rail base lower end 148 engages the body cleat 88 by extending through the body cleat aperture 64 to lock the lid 16 over the enclosure opening 14, and the lock cleats 22 are disposed between the lock rail openings 24 formed through the lock rail 18. One or more hasps of locking mechanisms are then inserted through the lock rail openings 24 and locked, such that attempted movement of the lock rail 18 to the unlock position engages the hasps with one of the lock cleats 22 to prevent slidable movement of the lock rail 18 and disengagement of the lock rail base lower end 148 from the body cleat 88.

The lid 16 is opened by unlocking all of the locking mechanisms, such that the hasp of each locking mechanism can be removed from the lock rail opening 24. Once the hasps are removed from the lock rail openings 24, the lock rail 18 is slid to the unlock position to disengage the lock rail base lower end 148 from the body cleat 88. Once the lock rail base lower end 148 is disengaged from the body cleat 88, the lid 16 is pivoted to the open position to gain access to the objects inside the enclosure 12.

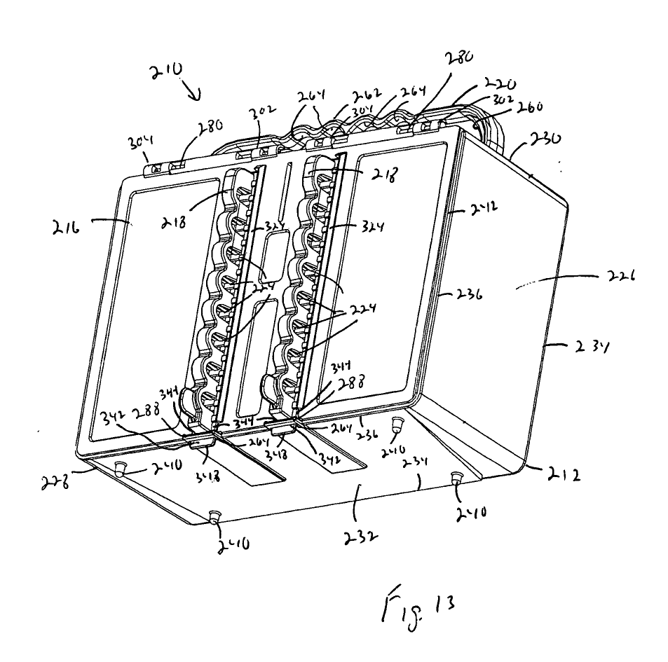

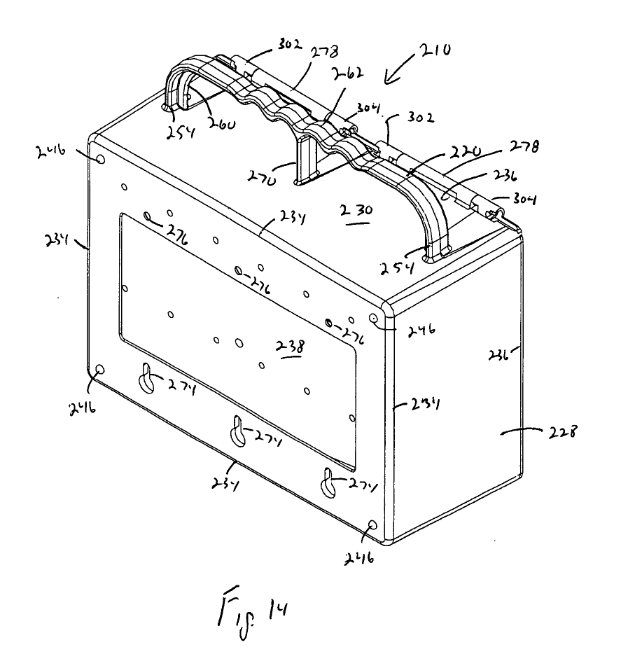

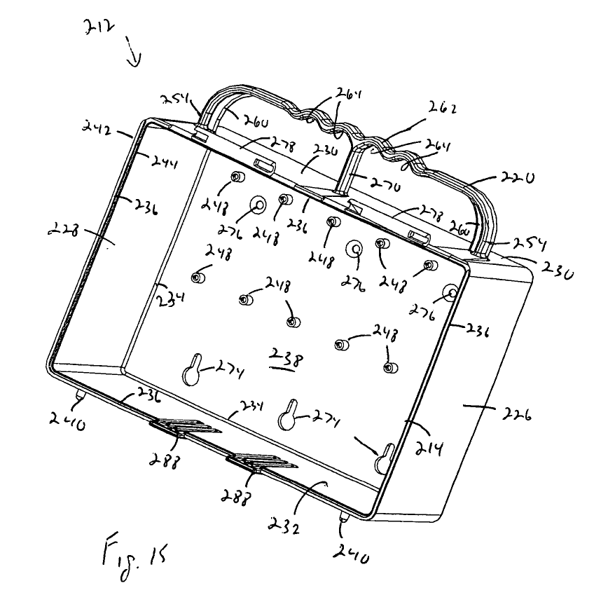

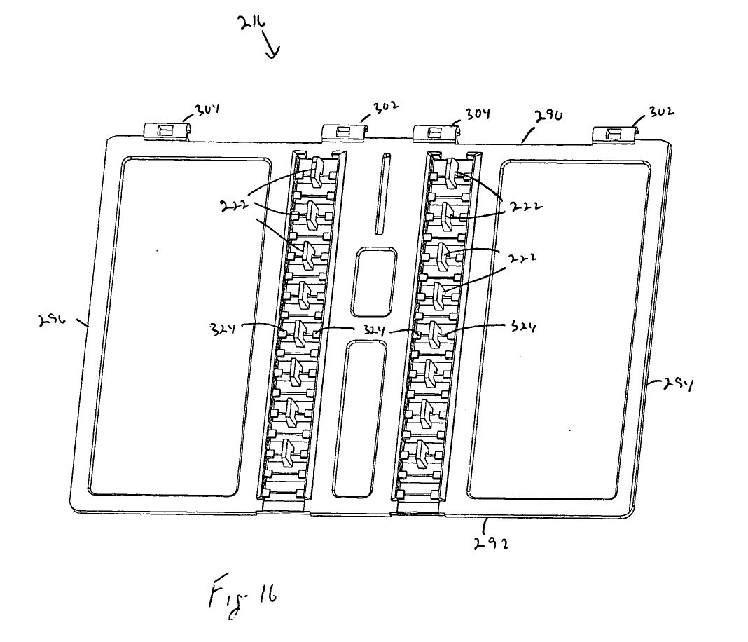

In another embodiment shown in FIGS. 13-16, a lockbox 210 incorporating the present invention includes a large enclosure 212 having an opening 214 for accessing objects in the enclosure 212. A lid 216 covering the opening 214 includes two lock rails 218 for locking the lid 216 over the opening 214 in the enclosure 212. This particular lockbox 210 includes a handle 220 for carrying the lockbox 210 to various locations, as well as, mounting holes 274, 276 for mounting the lockbox 210 to a wall, or other supporting surface.

The enclosure 212 in this embodiment includes side walls 226, 228 joined by top and bottom end walls 230, 232. The side walls 226, 228 and end walls 230, 232 have inner and outer edges 234, 236. The inner edges 234 of both the side and end walls 226, 228, 230, 232 are joined by a back wall 238. The outer edges 236 of both the side walls and end walls 226, 228, 230, 232 define the enclosure opening 214 into the enclosure 212. As in the first embodiment, an enclosure opening lip 242 formed on the outer edges 236 of the side and bottom end walls 226, 228, 232 form a ledge 244 for receiving the lid 216 thereon. The enclosure opening lip 242 abuts the adjacent lid edges 292, 294, 296 to prevent tampering.

Feet 240 extending downwardly from the bottom end wall 232 support the enclosure 212 on a horizontal surface. The feet 240 space the bottom end wall 232 from the horizontal surface. Advantageously, the feet 240 also space the lower end 348 of the lock rails 218 from the horizontal surface when the lock rails 218 are engaged with the enclosure 212 in the lock position to lock the lid 216 over the enclosure opening 214. Additional feet 246 extending rearwardly from the back wall 238 can also be provided to space the lockbox 210 from a vertical or horizontal surface when the back wall 238 is adjacent the vertical or horizontal surface.

The handle 220 extending upwardly from the enclosure top end wall 230 allows a user to easily carry the lockbox 210 to various locations. The handle 220 is preferably formed as an integral part of the enclosure 212, and is fixed to the enclosure at opposing ends 254. A center support 270 joining the handle 220 to the enclosure 212 midway between the handle ends 254 provides rigidity to the handle 220. Gussets 260 formed at each handle end 254 stiffen the junction at the handle end 254 and enclosure top end wall 230. An undulating shape 262 formed in the handle 220 between the handle ends 254 provides grooves 264 for receiving the user's fingers to comfortably grasp the handle 220 and carry the lockbox 210.

As in the first embodiment, the back wall 238 includes a plurality of key hook bosses 248, such as described above, for supporting key hooks, such as the key hooks 56 described above. Mounting holes 274, 276, such as described above, formed through the back wall 238 receive mechanical fasteners, such as screws, bolts, nails, and the like, therethrough for mounting the enclosure 212 to a wall, or other support structure.

A pair of spaced enclosure hinge members 278 are formed on the outer edge 236 of the top end wall 230. Each enclosure hinge member 278, is substantially identical to the enclosure hinge member 78 described above, and receives a hinge pin 280 to hingedly fix the lid 216 to the enclosure 212. Likewise, a pair of spaced body cleats 288 extend outwardly from the outer edge 236 of the enclosure bottom end wall 232 for engagement with the lock rails 218. Each body cleat 288 is substantially identical to the body cleat 88 described above, and engages one of the lock rails 218 to lock the lid 216 over the enclosure opening 214.

The generally flat lid 216 is hingedly fixed to the enclosure 212 by the hinge pins 280 for pivotal movement between an open position and a closed position, and includes a top edge 290 and bottom edge 292 joined by side edges 294, 296. In the open position, the lid 216 is clear of the enclosure opening 214 for depositing or retrieving objects from within the enclosure 212. In the closed position, the lid 216 covers the enclosure opening 214. Advantageously, in the closed position, the lid edges 292, 294, 296 abut the enclosure opening lip 242, such as described above, to prevent an unauthorized user from prying the lid 216 off of the enclosure 212. Preferably, the lid 216 is formed from a clear plastic, such as moldable nylon, polystyrene, polycarbonate, and the like, for clear viewing of the enclosure contents.

Two pairs of lid hinge members 302, 304 are formed in the top edge 290 of the lid 216. Each pair of lid hinge members 302, 304 receives one of the hinge pins 280 to hingedly fix the lid 216 to the enclosure 212. Each lid hinge member 302, 304 is substantially identical to the lid hinge members 102, 104 described above, and are spaced apart to receive one of the enclosure hinge members 278 therebetween.

Each lock rail 218 is substantially identical to the lock rail 18 described above, and is slidably mounted to the lid 216 over a plurality of aligned lock cleats 222 extending outwardly from the lid 216 between lid lips 324, as described above. The lock cleats 222 cooperate with transverse lock rail openings 224 formed through the lock rail 218, such that a hasp of a locking mechanism inserted through one of the lock rail openings 224 engages one of the lock cleats 222 to prevent slidable movement of the lock rail 218 to open the lid 216.

Each lock rail 218 is slidably mounted over the lock cleats 222 for slidable movement between a lock position and an unlock position by the lid lips 324 wrapping over longitudinal edges 344 of the lock rail base 342. In the lock position, the transverse lock rail openings 224 formed in the lock rail 218 are disposed between adjacent lock cleats 222 to allow a hasp of the locking mechanism through the lock rail openings 224, and the lower end 348 of the lock rail base 342 engages the body cleat 288 extending outwardly from the outer edge 236 of the enclosure bottom end wall 232 to lock the lid over the enclosure opening 214. In the unlock position, the lower end 348 of the lock rail base 342 disengages from the enclosure 212 to unlock the lid 216 from over the enclosure opening 214 and each transverse lock rail opening 224 is aligned with one of the lock cleats 222.

While there has been shown and described what are at present considered the preferred embodiments of the invention, it will be obvious to those skilled in the art that various changes and modifications can be made therein without departing from the scope of the invention defined by the appended claims. For example, the lock rail can be slidably fixed to a side wall or end wall without departing from the scope of the invention. Moreover, the enclosure can be formed from a clear plastic in addition to, or instead of, the lid to provide a user with a clear view of the lockbox contents.

1. A lockbox comprising:
an enclosure defining an opening;
a lid fixed relative to said enclosure for movement between an open position and a closed position, in said closed position, said lid covers said opening to discourage access to contents of said enclosure by an unauthorized user; and
a lock rail slidably mounted to said one of said lid and said enclosure, said lock rail being slidable between a lock position and an unlock position, in said lock position, said lock rail engages said other of said lid and said enclosure to prevent moving said lid from said closed position to said open position, said lock rail being selectively lockable to prevent slidable movement of said lock rail from said lock position to said unlock position.

2. The lockbox as in claim 1, in which said lid is hingedly fixed to said enclosure for pivotal movement of said lid between said open position and said closed position.

3. The lockbox as in claim 1, including at least one cleat extending outwardly from one of said lid and said enclosure, and said lock rail includes at least one opening adjacent said at least one cleat, such that a hasp of a locking mechanism inserted through said at least one opening adjacent said at least one cleat is engageable with said at least one cleat to prevent slidable movement of said lock rail from said lock position to said unlock position.

4. The lockbox as in claim 1, in which a pair of lips extending from said one of said lid and said enclosure wrap around longitudinally extending edges of said lock rail to slidably mount said lock rail to said one of said lid and said enclosure.

5. The lockbox as in claim 1, in which an end of said lock rail engages said other of said lid and said enclosure to prevent moving said lid from said closed position to said open position when said lock rail is in said lock position.

6. The lockbox as in claim 1, in which a key hook boss for receiving a key hook extends inwardly from a wall defining said enclosure.

7. The lockbox as in claim 6, in which said key hook boss includes an opening for receiving an end of said key hook, and said opening includes a slot for receiving a rib extending from said key hook to orient the key hook end in the opening.

8. The lockbox as in claim 1, in which said enclosure includes at least one wall having an edge defining said opening, and said edge includes a lip defining a ledge for supporting an edge of said lid.

9. The lockbox as in claim 1, in which said other of said lid and said enclosure includes a body cleat engageable with said lock rail to prevent moving said lid from said closed position to said open position.

10. The lockbox as in claim 1, in which a handle is fixed to said enclosure.

11. The lockbox as in claim 1, in which said enclosure includes side walls joined by a top end wall, a bottom end wall, and a back wall, said bottom end wall extending further from the back wall than the top end wall to slope outer edges of the side walls from the top end wall outwardly to the bottom end wall and provide an angled support for the lid.

12. The lockbox as in claim 1, in which at least one of said enclosure and said lid is formed from a clear plastic.

13. A lockbox comprising:
an enclosure including opposing side walls joined by a top end wall and a bottom end wall, each of said side walls and end walls including outer edges defining an opening;
a lid fixed relative to said enclosure for movement between an open position and a closed position, in said closed position, said lid covers said opening to discourage access to contents of said enclosure by an unauthorized user;
a lock rail slidably fixed to one of said lid and said enclosure for slidable movement between a lock position and an unlock position, wherein in said lock position, said lock rail engages said other of said lid and said enclosure to prevent moving said lid from said closed position to said open position; and
at least one of said enclosure side walls, said end walls, and said lid is formed from a clear plastic to provide a user with a view inside of said enclosure when said lid is in said closed position.

14. The lockbox as in claim 13, including at least one cleat extending outwardly from one of said lid and said enclosure, and said lock rail includes at least one opening, and in said lock position, said at least one opening is adjacent said at least one cleat, such that a hasp of a locking mechanism inserted through said at least one opening is engageable with said at least one cleat to prevent slidable movement of said lock rail from said lock position to said unlock position.

15. The lockbox as in claim 14, in which said lock rail covers said at least one cleat.

16. The lockbox as in claim 14, in which said lid is hingedly fixed to said enclosure for pivotal movement of said lid between said open position and said closed position.

17. The lockbox as in claim 13, in which a pair of lips extending from said one of said lid and said enclosure wrap around longitudinally extending edges of said lock rail to slidably mount said lock rail to said one of said lid and said enclosure.

18. The lockbox as in claim 13, in which an end of said lock rail engages said other of said lid and said enclosure to prevent moving said lid from said closed position to said open position when said lock rail is in said lock position.

19. The lockbox as in claim 13, in which a key hook boss for receiving a key hook extends inwardly from a wall defining said enclosure.

20. The lockbox as in claim 19, in which said key hook boss includes an opening for receiving an end of said key hook, and said opening includes a slot for receiving a rib extending from said key hook to orient the key hook end in the opening.

21. The lockbox as in claim 13, in which at least one of edges of said side walls and end walls includes a lip defining a ledge for supporting an edge of said lid.

22. The lockbox as in claim 13, in which said other of said lid and said enclosure includes a body cleat engageable with said lock rail to prevent moving said lid from said closed position to said open position.

23. The lockbox as in claim 13, in which a handle is fixed to said enclosure.
